(19) United States
(12) Patent Application Publication
(10) Pub. No.: US 2011/0294090 A1
(43) Pub. Date: Dec. 1, 2011

(54) NON-INVASIVE REFERENCE DEVICE

(75) Inventor: Ronald Jung, Kusnacht (CH)

(73) Assignee: Straumann Holding AG, Basel (CH)

(21) Appl. No.: 13/123,753

(22) PCT Filed: Oct. 12, 2009
(86) PCT No.: PCT/EP2009/007308

§ 371 Date: Aug. 17, 2011

(30) Foreign Application Priority Data
Oct. 15, 2008 (EP) 08018038.3

(51) Int. Cl. A61C 19/04

(52) U.S. Cl. 433/68; 433/215

(57) ABSTRACT

Non-invasive reference device to be temporarily fixed on a tooth. The reference device is made of biocompatible, radiopaque material and allows the determination of anatomical structures in a jaw.

The present invention relates to non-invasive reference devices for implants, in particular dental implants.

Dental implants are devices which are surgically implanted into the jawbone of a patient in areas where the patient is missing teeth. Said dental implants mimic the roots of the teeth and serve to support prosthetic caps, crowns and bridges.

Implants must be placed in a specific position and in alignment to the prospective teeth that they will eventually support. Therefore, the positioning of these dental implants must be precise to enable teeth to be made that will function properly and be aesthetic in appearance.

A surgical template may be used as a guide to assist the surgeon in positioning and angling the dental implant drill during dental implant surgery. Usually, in a first step, a wax model of a dental prosthesis is made using an impression that is taken of the patient's jaw. A replica of this wax model is then prepared in synthetic resin, in said replica openings are already provided, corresponding to a possible position for the implants, for the purpose of drilling holes in the jaw. A so-called CT-scan (computer tomography scan) then has to be made of this replica when it has been placed on the corresponding jaw of the patient, in order to determine the anatomical bone structure and the precise location of nerve bundles and blood vessels. In this way it is checked whether the drilling of holes for the implants is possible, taking into account the anatomical structure of the jaw, such as, inter alia, the position of nerve bundles or blood vessels present there. If it is found that the proposed position of the implants is unsuitable because, for example, nerve bundles or blood vessels would be touched during the drilling of holes, a new or an adapted model has to be produced.

In a subsequent step, a template is then produced on the basis of the above-mentioned replica, and the implants are placed in position. When these implants have been placed and the gums and the bone have healed after this surgical procedure, a number of impressions of the jaw together with the implants are taken, in order to produce a provisional model, i.e., a wax model, of the superstructure. This provisional model then has to be fitted on the patient. If the provisional model is satisfactory, the final superstructure is produced on the basis of this provisional model.

In a variant of the above method, the above-mentioned first step is to make a CT-scan of the jaw on which the superstructure is to be fixed, and a template is produced directly, on the basis of the electronic information from this CT scan. The superstructure is then further produced according to the technique described above.

WO 03/003933 describes a method for producing a superstructure for a toothless jaw. At least one reference element in the form of a mini-implant is fixed to the jaw, and the location of anatomical structures of the above mentioned jaw relative to this reference element is then determined, means being provided on the template for fixing the latter on the jaw relative to the reference element and, taking into account the determined location of the anatomical structures, the position of the aperture in the template is determined in such a way that the critical anatomical structures, such as nerve bundles or blood vessels, are not touched during the drilling of the above mentioned hole when the template has been fixed on the jaw.

However, the said mini-implants have to be implanted in the bone, which is intrinsically tied to a short operation by drilling a hole for each of these mini-implants. Placing these mini-implants is a critical step and it very much depends on the experience of the surgeon to avoid any injury of blood vessels or nerve bundles. Moreover, the mini-implants are often placed in regions of the jaw where the mucosa is quite thick rendering the necessary surgery to place said mini-implants intricate.

The problem of the present invention was to find an alternative for patients who still have a tooth, a stump of a tooth or who already have an implant or a prosthetic device.

The problem is solved by a non-invasive reference device according to claim 1. Preferred embodiments are subject to dependent claims.

A non-invasive reference device is intended to be temporarily fixed on a tooth, a tooth stump, an already present implant or a prosthetic device (e.g. a crown) and has at least one edge. Said device is made of a biocompatible, radiopaque material. Due to the reference device according to the present invention it is possible to determine the location of anatomical structures of the jaw relative to said at least one reference device. With the reference device according to the present invention it is possible to obtain comparable results concerning the anatomical structure of the jaw as obtained by the mini-implants. However, since no invasive step is necessary to obtain the required information it is much more convenient for the patient. Further, avoiding an additional invasive step eliminates the possible risk of infection and subsequent complications which is associated to any invasive step.

The non-invasive reference device has at least one edge.

Shapes such as edges and corners provide “landmarks” which are easily detectable in CT-scans. This “landmark” is used to determine the relative location of anatomical structures in the jaw. An edge is suitable as a reference point (“landmark”) for a 3D-scan (3-dimensional scan), since it is detectable with accuracy. In one embodiment of the present invention three reference devices with at least one edge are fixed on one tooth, one tooth stump, an implant or a prosthetic device in order to have three different reference points in the patient's mouth.

The edge can be formed simply by the boundary of the upper (distal) surface of the device. However, preferably the distal end of the device comprises a protruding feature, said protruding feature comprising said at least one edge. By distal end it is meant the opposing end of the device from the end arranged, in use, to be temporarily fixed to the surface of the tooth, tooth stump, pre-existing implant or prosthetic device. Preferably the at least one edge is linear. This increases the detectability of the edge by scanning technology.

The edge of the protruding feature can act as a “landmark” detectable during CT scans, thus allowing the reference device to be easily detected and used to determine the relative location of anatomical structures in the jaw.

In a preferred embodiment the distal end comprises at least two subareas which form the protruding feature. This feature can be, for example, a raised surface. In this example two flat subareas could be formed on either side of a third subarea, the third subarea being located in a plane distally remote from the other subareas. In some embodiments, the at least two subareas of the distal end slope upwards in the distal direction to meet and form an edge. In this way the edge forms the most distally remote part of the device. However, alternatively the edge may be formed by the boundary of the raised surface. In certain embodiments the protruding feature forms a point, or peak. In such embodiments at least three subareas are required, these subareas sloping upwards in the distal direction to meet and form a point.

Since said reference device is fixed on a tooth, a tooth stump, an implant or a prosthetic device (e.g. a crown) by an adhesive or cement, it is a non-invasive procedure, which is fast and comfortable for the patient. Possible adhesives are for instance light-curable adhesives. Examples for adhesives are composites and examples for cements are glasionomers.

Preferably the device is sized such that it can be fixed on a single tooth. This size of device would of course also be capable of attachment to a single tooth stump, already present implant or prosthetic device, referred to hereafter as other intraoral objects. This size of device enables easy placement of the device in any area of the mouth. Preferably the width of the device is less than the width of the tooth or other intraoral device to which it is intended to be temporarily fixed. This small size of device reduces the discomfort and inconvenience to the patient during the period of fixation.

Once the treatment has been terminated the dentist can remove the non-invasive reference device. The non-invasive reference device may be removed by breaking the cement. The removal of the reference device may irreversibly deform the device.

Radiopaque materials are materials that block the passage of radiant energy, e.g. radiation such as X-rays. Radiopaque materials block the passage of X-rays and are thus visible in X-ray scans.

In a preferred embodiment the biocompatible, radiopaque material is selected from the group consisting of titanium, titanium alloys, ceramics and plastics. Titanium and its alloys are preferred. Titanium shows an excellent biocompatibility, is radiopaque and—importantly—does not scatter radiation such as X-rays. Ceramics and plastics are even more preferred. An advantage of ceramics and plastics is the possibility to match their appearance, in particular their colour, to the surrounding environment (e.g. teeth). They may also be colourless. Ceramics and plastics often comprise a marker material, such as barium sulphate. Materials showing a high proportion of scattered radiation in an X-ray scan (e.g. steel) are less suitable for a non-invasive reference device according to the present invention.

It is possible for only part of the device to be made of the biocompatible, radiopaque material. The part of the device made from this material must include the edge intended to form the reference “landmark”. In a preferred embodiment however the entire reference device is formed from the biocompatible, radiopaque material. This enables the reference device to be integrally formed, thus simplifying construction and increasing structural integrity.

In another preferred embodiment the reference device has at least three edges. These edges, which may in addition form a corner (peak), are easily detectable in X-ray scans. Although already one edge is sufficient to provide a “landmark” relative to which the location of any other (anatomical) structure in the jaw can be determined, more than one edge is preferred since a plurality of edges and corners (peaks) further improves the precision of determining the location of other structures. This advantage also applies if different X-ray scans are superimposed.

Thus, if the reference device has only one edge usually three reference devices are employed in order to have three different “landmarks”. If, however, the reference device itself already comprises three edges, the use of one reference device is sufficient. Of course, use of more than one reference device having three edges further enhances precision.

A very simple example of a reference device in accordance with the present invention is a flat plate having the shape of a rectangle or a square. In this embodiment the edges formed at the boundary of the plate form linear edges. With a single reference device providing said “landmark” it would already be possible to obtain excellent results during a 3D-scan.

In other embodiments a distal end comprising a protruding feature is provided. This may take, for example, the form of a single protruding edge or raised surface, or multiple edges/surfaces.

In a preferred embodiment the reference device comprises fixing means. The fixing means are intended to be mounted on a template, e.g. a scan template or a drill template. In other words the fixing means are suitable for connection to such a template. The reference device having fixing means has not only the function to provide a reference in the determination of the relative location of other structures in the jaw, it also has the further function to serve as a fixation point for templates. It advantageously allows to (repeatedly) fix, for instance, a scan template. The fixing means comprised in the reference device and their respective counterpart comprised in the template provides a detachable connection between them. Thus, a template can be fixed on the reference device as many times as needed. Most advantageously, the spatial orientation of the template is always precisely the same as the reference device, temporarily fixed on tooth, remains in its position until it is no longer needed.

The reference device can be removed from the patient's tooth or tooth stump by the dentist only. This means that the information can not get lost between two consultations.

Additionally, if the template has to be fixed several times, it is guaranteed that it has all the time the same position in the patient's mouth.

Viewed from a further aspect therefore the present invention provides a dental restoration template comprising attachment means for connecting said template to the reference device of the present invention.

By dental restoration template is it meant a template used during the process of replacing or restoring teeth or parts of teeth. This term includes both scan and drill templates, as both of these can be used during the process of providing a patient with a dental implant.

Preferred fixing means are means for clicking, clamping and/or sliding. In this way the fixing means can provide a clicking, clamping and/or sliding connection to the template. Particularly preferred is a slide rail or a slide member.

In such embodiments the attachment means of the template comprises a complementary slide rail or member, in order to form a sliding assembly.

The slide rail or slide member may comprise a stop to limit relative movement of the sliding assembly. In a further embodiment the slide rail or slide member has a locking device. This makes it possible to prevent unwanted linear displacement. Such a locking element can be a pin, a screw or a detachable snap fit.

In one particularly preferred embodiment the slide rail or slide member has a dovetail configuration. This means essentially that the slide rail has a dovetail slot cross-section, whereas the slide members have a dovetailed projection cross-section. This construction allows simple assembly of the slide rail and the slide member. In addition the dovetailed slot cross-section of the slide rail allows very good guiding of the slide member. In some embodiments the dovetailed projection is adapted to the dovetail slot but with a flange on the top. This flange acts as a stop to limit relative movement between the fixing means and template. The slide member can additionally be secured by clamping to the slide rail. Alternatively or additionally the features of the sliding assembly (i.e. the slide rail and member) may form an interference (friction) fit.

In a particularly preferred embodiment, the protruding feature of the reference device is formed by the fixing means. This simplifies the design of the device while still enabling it to perform two discrete functions. For example, when the fixing means comprises a dovetail slot or a dovetail projection, the dovetail projection or the planar surfaces on either side of the dovetail slot may act as the protruding feature.

According to one embodiment of the present invention the reference device comprises fixing means which are intended to be mounted on a template. Due to the fixation of the template on the reference device, the template is no longer fixed on the tooth itself but on the fixing means of the reference device. Therefore, the template can not slip away, which is dangerous during drilling.

Said fixing means are preferably means for clicking, clamping and/or sliding. The fixing means of the reference device is an element which engages the counterpart of the template. Such clicking, clamping and/or sliding means are known to a person skilled in the art. Examples are slide rail and slide member, snap fastener.

According to another aspect of the present invention there is provided a template for drilling a hole in the bone of a lower or an upper jaw in order to place at least one implant, comprising means which are intended to be fixed on the fixing means of the reference device according to the present invention.

According to a further aspect of the present invention there is provided a dental restoration kit comprising at least one non-invasive reference device for temporary fixation to a tooth, tooth stump, implant or prosthetic device, said device being made of a biocompatible, radiopaque material and comprising at least one edge and fixing means, and a dental restoration template comprising attachment means, wherein said fixing and attachment means comprise complementary features which enable the template to be connected to the reference means while the reference means is fixed to a tooth, tooth stump, implant or prosthetic device.

The kit may further comprise at least one protection cap for covering the at least one reference device. Such a protection cap may either comprise or consist of wax which covers the non-invasive reference device. The protection cap may also be made of any other suitable material, such as ceramics or plastics. It is attached to the reference device in any suitable manner. The protection cap advantageously prevents irritation or injury of surrounding structures (e.g. tissue, mucosa) and it is further possible to match the appearance of the protection cap (in particular the colour) to its environment, which allows an aesthetic appearance. Thus, in case the non-invasive reference device is made of titanium, the appearance of metal can be avoided by covering it.

By using the reference device according to the present invention a drill template may be produced. First, a wax model is made using an impression that is taken from the patient's jaw. Then a scan template is prepared based on said wax model comprising fixing (attachment) means which are the counterpart of the fixing means of the reference device. The fixing means of the reference device are engaged with the fixing (attachment) means of the template. The template and the reference device together are then brought into the correct position in the patient's mouth. The fixing means of the reference device is fixed on the patient's tooth or tooth stump by a light curable adhesive. Of course also other adhesives or cements are usable for this purpose. After fixation of the reference device the template may be removed as often as it is required (comfort of the patient etc.). A CT-scan has then to be made when the scan template has been placed on the correct position, in order to determine the anatomical bone structure and the precise location of nerve bundles and blood vessels. Thereafter, the scan template is removed and converted into a drill template by bringing (creating) openings in the template on the position which correspond to the insertion point of the implant. Said opening is provided with a guiding cylinder in order to allow an optimal guiding of a drill. The conversion of the scan template into the drill template has the advantage that no information gets lost which could be the case if a template is produced based on a replica, which of course would also be possible with the reference device according to the present invention.

In addition, the reference devices of the present invention can be fixed to one or more teeth or other intraoral objects in the patient's mouth after which an initial CT scan of the jaw is undertaken. Based on the information obtained during this scan a drill template can be produced directly. This template can have attachment means arranged for connection to the fixing means of the one or more reference devices, which remain fixed in the patient's mouth. Once the reference devices are no longer needed they are removed by the dentist. The placement and removal of these devices does not require any surgical steps.

The non-invasive reference device according to the present invention will be explained in more detail in the following text with reference to one exemplary embodiment, which is illustrated in the drawings and in which, purely schematically:

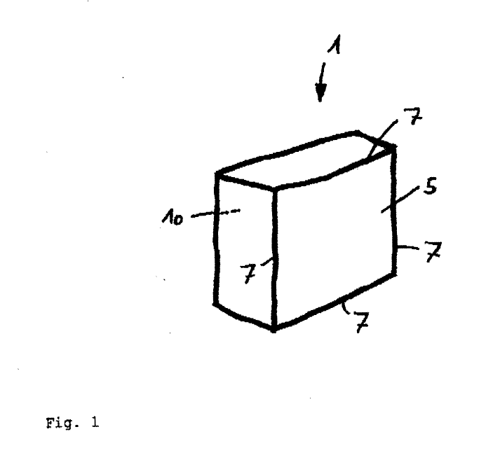

FIG. 1 shows a first embodiment of the non-invasive reference device;

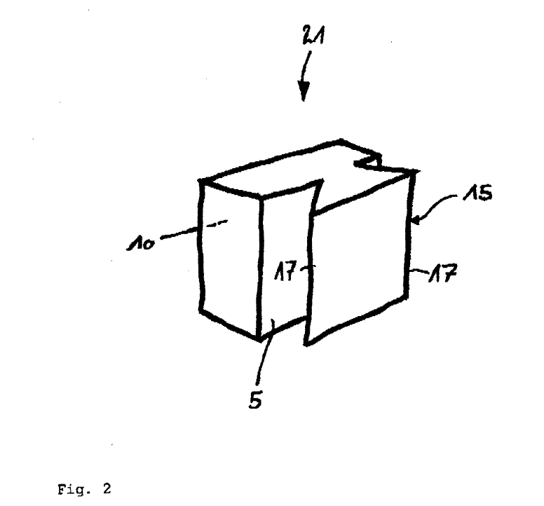

FIG. 2 shows a second embodiment of the non-invasive reference device having fixing means;

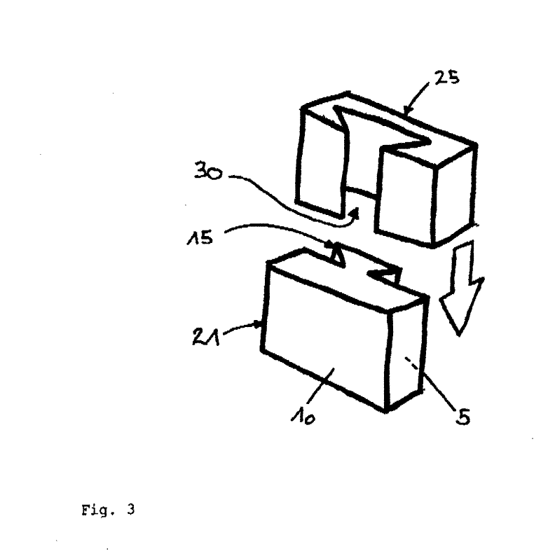

FIG. 3 shows the non-invasive reference device of FIG. 2 and its respective counterpart in an exploded view;

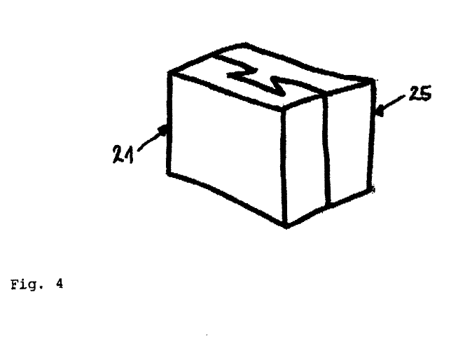

FIG. 4 shows the reference device and its respective counterpart of FIG. 2 when the fixing means are engaged;

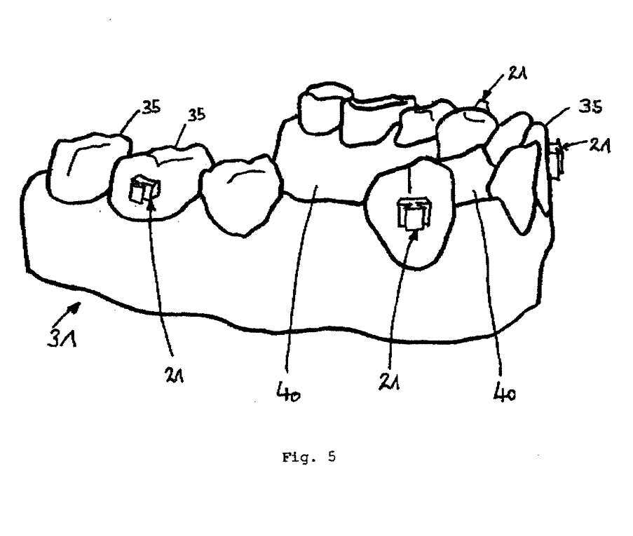

FIG. 5 shows a lower jaw with four reference devices fixed on four different teeth; and

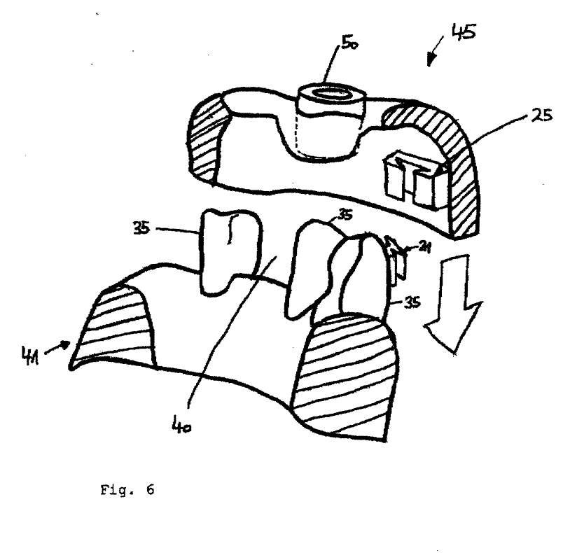

FIG. 6 shows a part of a lower jaw and a drill template.

FIG. 1 shows a simple embodiment of non-invasive reference device 1 having the shape of flat plate with a substantially square front side 5 and a substantially square back side 10. The reference device is fixed on a tooth by treating the back side 10 with an adhesive and subsequently placing it in a desired position on the tooth. The front side 5 forms the distal end of the device 1. The edges 7 at the boundary of the front side 5 act as a landmark during scanning and allow determination of the location of anatomical structures of the jaw relative to the device 1.

FIG. 2 shows a second embodiment of the reference device 21. In contrast to the first embodiment shown in FIG. 1 this embodiment comprises fixing means 15. Again the reference device 21 has the shape of a flat plate with a substantially square front side 5 forming a distal end and a substantially square back side 10. The fixing means 15 which has the shape of a dovetailed projection is located on the front side 5 and forms a protruding feature. Said dovetailed projection is a guide member which is intended to be inserted in a (corresponding) slide rail (a dovetail slot). In addition edges 17 can be used during scanning as “landmarks”.

FIG. 3 shows again the reference device 21 of FIG. 2 together with the counterpart 25 of the fixing means 15. The reference device 21 is shown from the rear, whereby the back side 10 is visible. The front side 5 is not and the dovetailed projection 15 is only partly visible. The counterpart 25 has a dovetail slot 30. The arrow in FIG. 3 indicates how the reference device 21 and the counterpart 25 are assembled when the dovetailed projection and the dovetail slot are engaged.

FIG. 4 shows the reference device 21 and the counterpart 25 of FIG. 3 in the state where the fixing means 15 and (the dovetailed projection 15 and the dovetail slot 30) are engaged. The counterpart 25 is fixed for instance on a template (not shown). The fixing means 15 and 30 provide a secure and detachable connection between the reference device and the template.

FIG. 5 shows a lower jaw 31 with teeth 35. The situation shown is typical for patients in need of dental implants. While most of the teeth 35 are present, there are two teeth missing as indicated by the gaps 40. Four non-invasive reference devices 21 are (temporarily) fixed on four different teeth 35. The devices 21 are sized such that each device can be fixed to a single tooth.

FIG. 6 shows a part of lower jaw 41 with teeth 35. On a tooth 35 of the lower jaw 41 a non-invasive reference device 21 is (temporarily) fixed. Also shown is a drill template 45 with guiding means 50 (in the form of a hollow cylinder) for a drill and the counterpart 25 fixed to the drill template 45 to form attachment means. Once the fixing means of the reference device and its counterpart are engaged, the drill template 45 is securely and detachably attached to the lower jaw and the guiding means 50 for the drill lies in the gap 40 where a tooth 35 of the lower jaw 41 is missing.

The shape of the non-invasive reference device does not necessarily have to be a small flat plate with substantially square front and back sides. It may also have rectangular, polygonal or round front and back sides. The non-invasive reference device may also have any other suitable shape.

In lieu of dovetailed projections as fixing means also other shapes may be used, e.g. half a dovetailed projection or a substantially round projection.

The non-invasive reference device may further comprise a protection cap.

1. A device comprising a non-invasive reference device to be temporarily fixed on a tooth or a tooth stump, an implant or a prosthetic device, said reference device having at least one edge made of a biocompatible, radiopaque material.

2. A non-invasive reference device as claimed in claim 1 wherein the at least one edge is linear.

3. A non-invasive reference device as claimed in claim 1 wherein a distal end of the device end comprises a protruding feature, said protruding feature comprising said at least one edge.

4. A non-invasive reference device as claimed in claim 1 wherein the device is sized to be fixed to a single tooth.

5. Reference device according to claim 1, wherein the biocompatible, radiopaque material is selected from the group consisting of titanium, titanium alloys, ceramics and plastics.

6. Reference device according to claim 1, wherein the device has at least three edges, whereby said edges can be being arranged independently from each other or forming a peak.

7. Reference device according to claim 1, wherein the device comprises fixing means for connection to a template.

8. Reference device according to claim 1, wherein said fixing means are means for clicking, clamping and/or sliding.

9. Reference device according to claim 8, wherein the fixing means is a slide rail or a slide member.

10. Reference device according to claim 9, wherein the slide rail has the shape of a dovetail slot or the slide member has the shape of a dovetail projection.

11. A dental restoration template comprising attachment means for connecting said template to a reference device as claimed in claim 7.

12. A restoration dental kit comprising
at least one non-invasive reference device for temporary fixation on a tooth, tooth stump, an implant or a prosthetic device, wherein said reference device comprises at least one edge made of a biocompatible, radiopaque material and has fixing means, and
a dental restoration template comprising attachment means,
wherein said fixing and attachment means comprise complementary features which enable the template to be connected to the reference means while the reference means is fixed to a tooth, tooth stump, implant or prosthetic device.

13. A dental kit as claimed in claim 12, further comprising at least one protection cap for covering the at least one non-invasive reference device.

14. A method of determining location comprising use of at least one reference device according to claim 1 to determine the location of anatomical structures of a jaw.

15. A method of preparing a drill template comprising use of at least one reference device according to claim 1, the method including preparing a scan template of a wax model of a patient, the scan template and the reference device having fixing means wherein the reference device is connected to the template, determining the anatomical structure of the jaw relative to said reference device, converting the scan template to a drill template by providing the scan template with holes and providing said holes with guiding cylinders.

16. The method of claim 15, wherein the fixing means provide a detachable connection.

17. The method of claim 15, wherein the device has at least three edges, said edges being arranged independently from each other or forming a peak.

18. The method of claim 15, wherein said fixing means are means for clicking, clamping and/or sliding.

19. The method of claim 18, wherein said fixing means is a slide rail or a slide member.

20. The method of claim 15, wherein a distal end of the device comprises a protruding feature, said protruding feature comprising said at least one edge.
